(19) United States
(12) Patent Application Publication
(10) Pub. No.: US 2026/0356265 A1
(43) Pub. Date: Nov. 12, 2026

(54) SEAT ASSEMBLY, MESH MEMBER, AND METHOD OF MANUFACTURE

(71) Applicant: LEAR CORPORATION, Southfield, MI (US)

(72) Inventors: Bradley C. DUNCAN, Harrison Twp, MI (US); Vyachislav IVANOV, West Bloomfield, MI (US); Amanda PUCHER, Farmington Hills, MI (US); Lisa SWIKOSKI, West Bloomfield, MI (US); Michael SCHWALM, Auburn Hills, MI (US)

(21) Appl. No.: 19/671,780

(22) Filed: May 8, 2026

Related U.S. Application Data
(60) Provisional application No. 63/802,282, filed on May 8, 2025.

(51) Int. Cl. B60N 2/70

(52) U.S. Cl. CPC B60N 2/7017

(57) ABSTRACT

A seat assembly, a mesh member, and a method of manufacture. The mesh member comprises a set of filaments of thermoplastic material. Each member of the set of filaments is bonded to at least one other member of the set of filaments. The set of filaments are shaped with a tool to form a membrane along an exterior side of the mesh member. A method of manufacturing a mesh member includes: extruding a set of filaments from a die, each filament having a first cross-sectional shape when extruded; shaping a subset of the set of filaments with a tool while the set of filaments are in a molten state to change the first cross-sectional shape to a second cross-sectional shape that differs from the first cross-sectional shape; passing the set of filaments through a funnel to entangle and bond the set of filaments together to form the mesh member.

### CROSS-REFERENCE TO RELATED APPLICATIONS

This application claims priority to U.S. Provisional Application Serial No. 63/802,282, filed on May 8, 2025, the contents of which are hereby incorporated by reference in their entirety.

### TECHNICAL FIELD

This relates to a seat assembly, a mesh member, and a method of manufacture.

### BRIEF DESCRIPTION OF THE DRAWINGS

FIG. 1 is a perspective view of an example of a seat assembly comprising a mesh member.

FIG. 2 is schematic view of an example of a manufacturing system for making the mesh member.

FIG. 3 is a magnified view of an example of the mesh member.

FIG. 4 is a top section view of an example of some filaments extruded by the manufacturing system.

FIGS. 5 and 6 are top section views of the filaments shown in FIG. 4 and examples of some filaments after being shaped with a tool.

FIG. 7 is a perspective view of an example of the mesh member with a membrane along multiple sides of the mesh member.

FIG. 8 is a side view of a portion of the manufacturing system and an example of a first configuration of a tool positioned above liquid in a cooling tank of the manufacturing system.

FIG. 9 is a side view of a portion of the manufacturing system and an example of the first configuration of a tool positioned at least partially in liquid in the cooling tank of the manufacturing system.

FIG. 10 is a side view of a portion of the manufacturing system and an example of a second configuration of a tool positioned above liquid in a cooling tank of the manufacturing system.

FIG. 11 is a side view of a portion of the manufacturing system and an example of the second configuration of a tool positioned at least partially in liquid in the cooling tank of the manufacturing system.

FIG. 12 is a side view of a portion of the manufacturing system and an example of a third configuration of a tool positioned above liquid in a cooling tank of the manufacturing system.

FIG. 13 is a side view of a portion of the manufacturing system and an example of the third configuration of a tool positioned at least partially in liquid in the cooling tank of the manufacturing system.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a” and “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

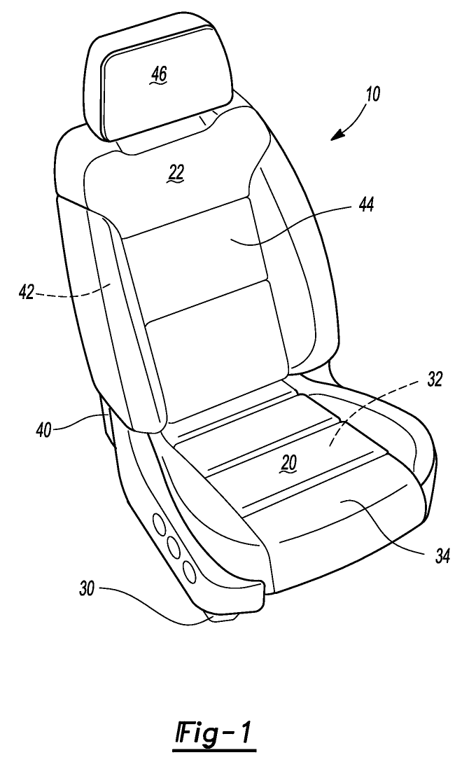

Referring to FIG. 1, an example of a seat assembly 10 is shown. In some embodiments, the seat assembly 10 is a vehicle seat assembly, such as for a land vehicle like a car, truck, bus, or the like, or for a non-land vehicle like aircraft or watercraft. For example, a seat assembly 10 for a land vehicle may be shaped and sized as a front row driver or passenger seat, a second, third, or other rear row seat, and may include bucket-style seats, bench-style seats, or other seat styles. Furthermore, the seat assembly 10 may be a non-stowable seat or a stowable seat that may be foldable and stowable in a cavity in the vehicle floor. Additionally, the seat assembly 10 may be configured for non-vehicle applications such as furniture.

In the configuration shown in FIG. 1, the seat assembly 10 includes a seat bottom 20 and a seat back 22. It is contemplated that the seat back 22 may be omitted in some configurations, such as when the seat assembly 10 is configured as a motorcycle seat or stool.

The seat bottom 20 is configured to receive a seated occupant and support the pelvis or pelvis and thighs of the seat occupant. The seat bottom 20 includes a seat bottom frame 30, a cushion 32, and a trim cover 34.

The seat bottom frame 30 is a structure that supports the cushion 32. The seat bottom frame 30 includes one or more structural members and may be made of any suitable material, such as a metal alloy, polymeric material, fiber reinforced polymeric material, or combinations thereof. In some configurations, the seat bottom frame 30 includes a panel, seat pan, suspension mat, or suspension wires upon which the cushion 32 is disposed.

The cushion 32 is disposed on the seat bottom frame 30. The cushion 32 is made of a compliant material that supports the seat occupant and distributes load forces from the seat occupant to the seat bottom frame 30. The cushion 32 and associated methods of manufacture will be discussed in more detail below.

The trim cover 34 covers at least a portion of the cushion 32. In addition, the trim cover 34 provides one or more visible exterior surfaces of the seat back 22. The seat occupant may be disposed on the trim cover 34 when seated upon the seat assembly 10. The trim cover 34 is made of any suitable material or materials, such as fabric, leather, leatherette, vinyl, or combinations thereof. The trim cover 34 may include a plurality of trim panels that are assembled in any suitable manner, such as by fusing or stitching. The trim cover 34 is attached to the seat bottom frame 30, the cushion 32, or both. For example, the trim cover 34 may include trim attachment features that are attached to the seat bottom frame 30, the cushion 32, or both, to inhibit removal of the trim cover 34 and help conform the trim cover 34 to the contour of the seat bottom frame 30, the cushion 32, or both. In some configurations, the trim cover 34 may also be attached to an attachment pad.

The seat back 22 is configured to support the back of a seated occupant. The seat back 22 is disposed adjacent to the seat bottom 20. For example, the seat back 22 may be disposed above the seat bottom 20 and near the rear side of the seat bottom 20. The seat back 22 extends in a generally upward direction away from the seat bottom 20. In some configurations, the seat back 22 is mounted to the seat bottom 20 and may be pivotable with respect to the seat bottom 20. In other configurations, the seat back 22 is not mounted to the seat bottom 20. For instance, a vehicle seat back may be mounted to the vehicle body structure, such as in some second row seat assemblies. The seat back 22 includes a seat back frame 40, a cushion 42, a trim cover 44, and optionally a head restraint 46.

The seat back frame 40 is a structure that supports the cushion 42. The seat back frame 40 includes one or more structural members and may be made of any suitable material, such as a metal alloy, polymeric material, fiber reinforced polymeric material, or combinations thereof. In some configurations, the seat back frame 40 includes a panel, pan, suspension mat, or suspension wires upon which the cushion 42 is disposed. It is also contemplated that the seat back frame 40 may be integrally formed with the seat bottom frame 30 in some configurations.

The cushion 42 is disposed on the seat back frame 40. The cushion 42 is made of a compliant material that supports the seat occupant and distributes load forces from the seat occupant to the seat back frame 40. It is contemplated that the cushion 42 may be integrally formed with the cushion 32 of the seat bottom 20 or may be separate from the cushion 32 of the seat bottom 20. The cushion 42 and associated methods of manufacture will be discussed in more detail below.

The trim cover 44 covers at least a portion of the cushion 42. In addition, the trim cover 44 provides one or more visible exterior surfaces of the seat back 22. The seat occupant may be disposed on the trim cover 44 when seated upon the seat assembly 10. The trim cover 44 is made of any suitable material or materials, such as fabric, leather, leatherette, vinyl, or combinations thereof. The trim cover 44 may include one trim panel or a plurality of trim panels that are assembled in any suitable manner, such as by fusing or stitching. The trim cover 44 is attached to the seat back frame 40, the cushion 42, or both. For example, the trim cover 44 may include trim attachment features that are attached to the seat back frame 40, the cushion 42, or both, to inhibit removal of the trim cover 44 and help conform the trim cover 44 to the contour of the seat back frame 40, the cushion 42, or both. In some configurations, the trim cover 44 may also be attached to an attachment pad.

The head restraint 46, if provided, is configured to support the head of a seat occupant. The head restraint 46 is disposed at the top of the seat back 22 or at an end of the seat back 22 that is disposed opposite the seat bottom 20. The head restraint 46 may be moveable in one or more directions with respect to the seat back 22 or may be integrally formed with the seat back 22.

Referring to FIG. 3, a simplified fragmentary view of an example of a cushion 50 is shown. The cushion is generically designated with reference number 50 for convenience in reference. It is to be understood that the structure and description of the cushion 50 is applicable to the cushion 32 of the seat bottom 20, the cushion 42 of the seat back 22, or both.

The cushion 50 is a non-foam component or includes at least one non-foam component. The non-foam component is primarily referred to as a mesh member but may also be referred to as a stranded member, looped member, entangled member, filament mesh structure, mesh structure, stranded mesh, looped mesh, entangled mesh, or mesh cushion. In FIG. 3, the cushion 50 is depicted as a non-foam component that does not include a foam component or foam material, such as urethane or polyurethane foam; however, it is contemplated that the cushion 50 may also include a foam component or foam material in addition to a non-foam component to provide additional cushioning or localized cushioning for a seat occupant. For example, foam material may be provided between the cushion 50 and a trim cover (e.g., trim cover 34, 44) that is disposed on the cushion 50, within the cushion 50, or combinations thereof. Reducing the amount of foam material that is provided with the cushion 50 or eliminating foam material from the cushion 50 reduces weight and may improve support and comfort of a seat occupant. In addition, eliminating foam material may facilitate recycling of the cushion 50.

The cushion 50 is described below in the context of a cushion 50 that does not include foam material. In this context, the cushion 50 is made of filaments 52 of polymeric material that are randomly looped, bent, curled, or entangled and are bonded together as will be discussed in more detail below. A filament 52 is directly bonded to another filament 52 rather than being indirectly bonded with a resin or other intermediate material.

The filaments 52, which may also be referred to as strands or threads, are made of any suitable material or materials. In some configurations, the filaments 52 are made of a polymeric material or thermoplastic material, such as a thermoplastic resin that is polyamide-based, polyester-based, polyimide-based, polyolefin-based (e.g., polypropylene-based, polyethylene-based, etc.), polystyrene-based, or combinations thereof. As one example, a polyethylene-based filament may be made of linear low-density polyethylene (LLDPE). The filament material may be recyclable unlike foam material or more easily recycled than foam material. It is also contemplated that a filament 52 may comprise reinforcement fibers and that the reinforcement fibers may not be made of a thermoplastic material.

In some configurations, a filament 52 may be a monofilament that is made of a single material. In some configurations, a filament 52 is made of multiple materials. As an example, a filament 52 made of multiple materials may include a core that is made of a first thermoplastic material and a sheath that encircles the core and is made of a second thermoplastic material that differs from the first thermoplastic material. It is contemplated that the cushion 50 may include a combination of monofilaments and filaments that are made of multiple materials and are not monofilaments.

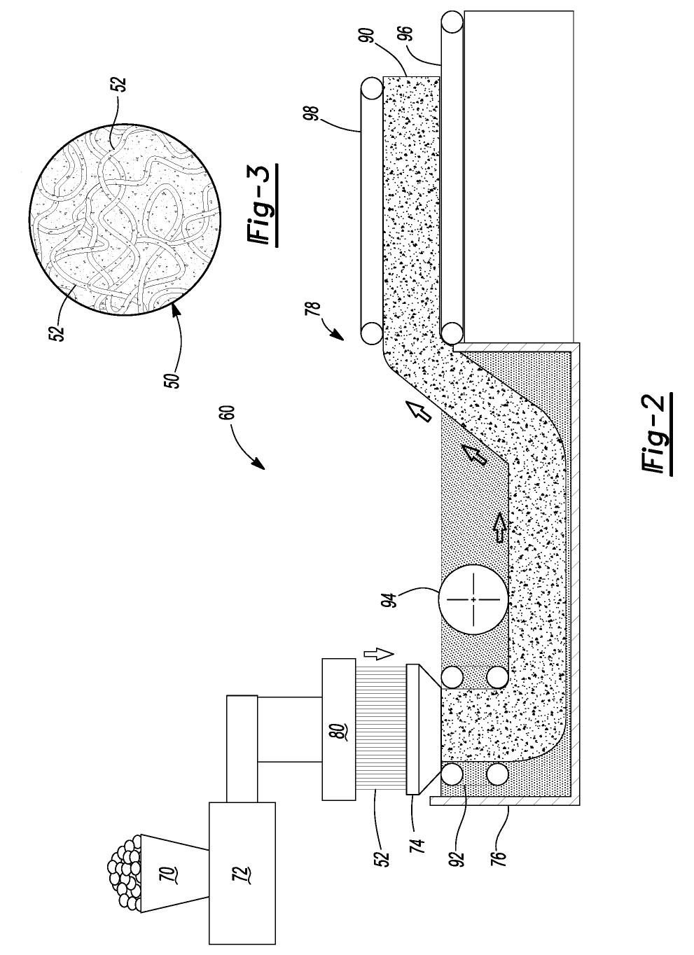

Filaments 52 that are randomly looped, bent, looped, curled, or entangled are bonded together where one filament 52 contacts another filament 52, thereby resulting in a lightweight, air permeable cushion 50 (e.g., cushion 32 and/or 42) or mesh structure having openings or voids between the filaments 52. An example of a manufacturing system 60 of making a cushion or filament mesh structure is also shown in FIG. 2. In this example, the manufacturing system 60 includes a material supply 70, an extruder 72, and a funnel 74. The manufacturing system 60 also includes a cooling tank 76 and a material handling subsystem 78.

Referring to FIG. 2, the material supply 70 holds material stock that is to be extruded, such as solid beads, flakes, granules, pellets, or powder made of the material. In some configurations, the material supply 70 is configured as a container or hopper. The material supply 70 provides material stock to the extruder 72.

The extruder 72 melts the material stock and extrudes the material stock into a set of filaments 52. The extruder 72 may have any suitable configuration. In some configurations, the extruder 72 includes a barrel that receives a rotatable screw and heating elements. Rotation of the screw forces the material to move through the barrel and helps heat the material due to the friction generated as the screw rotates. The material exits the barrel under pressure and in a molten state and is transported under pressure to a die 80 of the extruder 72.

The die 80, which may also be referred to as a die plate or extrusion die, has multiple through holes or filament forming openings through which the molten material passes. A single filament 52 is extruded from each through hole. The filaments 52 fall downward from the die 80 under the force of gravity into the funnel 74.

The funnel 74 consolidates or groups the filaments 52 into a more compact arrangement in which the filaments bend, curl, or loop and a filament 52 contacts and bonds to at least one other filament 52. The funnel 74 is a hollow member comprising an inlet opening or funnel inlet and an outlet opening or funnel outlet that is smaller than the funnel inlet. Individual separated filaments 52 enter the funnel inlet. The filaments 52 bend, curl, or loop and move into contact as they accumulate. The filaments 52 move through the funnel 74 toward the funnel outlet. Some filaments 52 may slide along the funnel 74 or an intervening sheet that is disposed on the funnel 74 as the filaments 52 move toward the funnel outlet. Bonds are formed between filaments 52 at the points of contact while openings or voids between filaments 52 are present at other locations where one filament 52 does not contact or bond to another filament 52. The entangled and bonded filaments 52 pass through the funnel outlet of the funnel 74 and enter the cooling tank 76. For convenience in reference, the bonded filaments 52 are referred to as a mesh member 90 or filament mesh structure.

The cooling tank 76 holds a liquid, such as water or a mixture of water and another fluid. The liquid in the cooling tank 76 helps support the entangled and bonded filaments 52 to limit further compacting or consolidation of the filaments 52 into a less open or less porous arrangement and maintains a desired porosity and density of the mesh member 90. Thus, the liquid provides some buoyancy or resistance that can result in additional bending, curling, or looping of the filaments 52 adjacent to the surface of the liquid or within the funnel 74 to further build the mesh member 90. The liquid also cools the filaments 52 when the filaments 52 are in the liquid (e.g., the liquid may have a temperature less than the temperature of the molten filaments 52). For instance, the liquid cools the filaments 52 from the outside to solidify the filaments 52 and prevent the filaments 52 from bonding at additional locations. When sufficiently cooled, the filaments 52 are relatively stiff and no longer in a plastic state and thus generally maintain a shape and are not moldable or reformable without being reheated.

The material handling subsystem 78 transports the mesh member 90 through the cooling tank 76. The material handling subsystem 78 includes various rollers and conveyors that help move the mesh member 90 through the liquid and out of the liquid. In some configurations, a tractor conveyor 92 is provided in the cooling tank 76 to help pull the mesh member 90 away from the funnel 74 and to counter buoyancy of the filaments 52.

One or more other rollers, such as roller 94, keep the mesh member 90 submerged in the liquid and guide the mesh member 90 through the cooling tank 76. For example, the roller 94 may guide the mesh member 90 toward a conveyor belt 96 and shaker table 98 that are disposed outside of the cooling tank 76. The shaker table 98 shakes the mesh member 90 while it is on the conveyor belt 96 to remove liquid. Alternatively or in addition, the mesh member 90 may be squeezed to remove liquid, air may be blown toward the mesh member 90 to help remove liquid from the mesh member 90, or both. It is also contemplated that the mesh member 90 may also be allowed to drip dry, or dry in ambient air.

The manufacturing system 60 described above is a continuous flow process in which the mesh member 90 is formed as a continuous structure when filament extrusion is not interrupted. Further processing of the mesh member 90 is provided after exiting the cooling tank 76 to cut the mesh member 90 into individual pieces or blanks for individual cushions. Such processing is conducted by a cutting subsystem of the manufacturing system 60. The cutting system may be of any suitable type. For instance, the cutting system may employ a blade, knife, hot knife, saw, fluid jet, or the like to cut the filaments 52 of the mesh member 90 into a blank. The cutting system may be used to shape or contour the blank. It is also contemplated that a blank may be further shaped or contoured with other manufacturing processes, such as molding of the entire blank or a portion thereof.

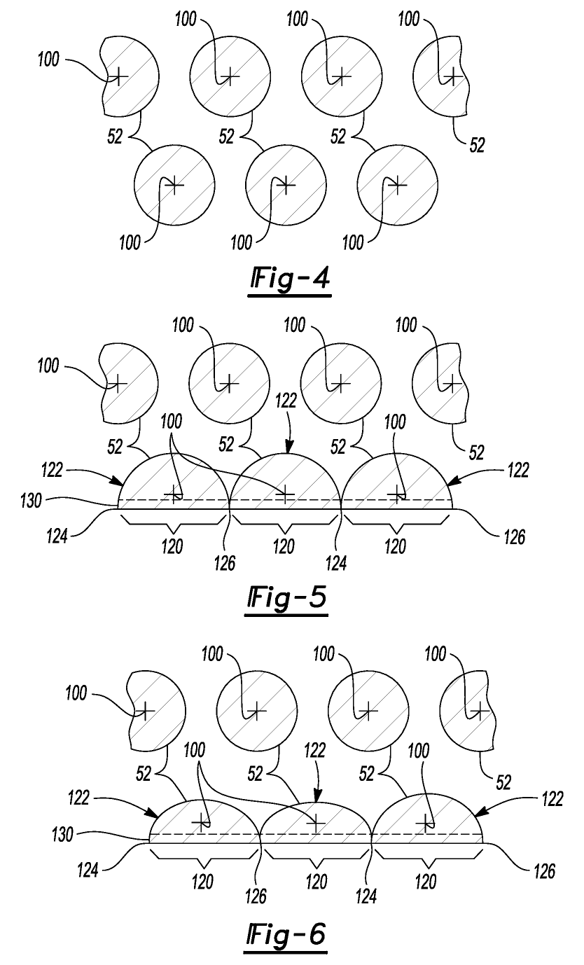

Referring to FIGS. 4-13, examples of mesh members and associated methods of manufacture will now be discussed in further detail.

As an overview, the present invention shapes filaments 52 (e.g., changes the shape of, changes a cross-sectional shape of a filament from the shape the filament had when it was extruded or exited the extruder) with a tool when the filaments 52 are in a molten state. The tool (e.g., one or more rollers, brushes, blades, etc.; a roller rotating faster than that tractor conveyor and exerting less pressure on the filaments than the tractor conveyor; brush comprising bristles that contact the filament; the tool contacts, engages, pushes, smears, or moves a portion of one or more filaments into engagement; the tool changes the cross-sectional shape of a filament where it contacts the filament from the cross sectional shape the filament had when the filament when the filament was extruded, etc.) engages or contacts one or more filaments 52 and changes the cross-sectional shape of at least a portion of a filament 52, such as a filament 52 that is disposed along an exterior side 110 (e.g., outer side, periphery, etc.) of the mesh member 90. The resulting mesh member 90 includes one or more filaments 52 or members of the set of filaments 52 that may comprise a different cross-sectional shape than when the filament 52 exited the extruder 72. A cross-sectional shape of a filament 52 is the shape of a filament 52 that would be exposed by making a straight cut through the filament 52 perpendicular to a filament axis 100 or center axis of the filament 52 in the direction of extrusion.

Examples of cross-sectional shapes are best understood with reference to FIGS. 4-6.

In FIG. 4, examples of filaments 52 are shown that have a circular cross-section, such as may be provided when a filament 52 exits the die 80 of the extruder 72. Thus, a filament 52 may have a first cross-sectional shape (in this example a circular cross-sectional shape) when extruded from the die 80. In some configurations, the first cross-sectional shape symmetrical around or with respect to the filament axis 100.

The tool may engage or contact one or more filaments 52 to change the cross-sectional shape of one or more filaments 52. For instance, the tool may engage or contact a filament 52 and shape the filament 52 so that the filament 52 has a second cross-sectional shape that differs from the first cross-sectional shape. Some examples of filaments and second cross-sectional shapes are shown in FIGS. 5 and 6.

The second cross-sectional shape may or may not vary from filament to filament. In FIG. 5, an example is shown in which the filaments 52 near the bottom of this figure from the perspective shown have been shaped with a tool and each filament 52 has the same cross-sectional shape or a substantially similar cross-sectional shape. Such a configuration may more likely be obtained when a filament 52 is shaped with the tool when the filament 52 falls from the die 80 toward the funnel 74 or when the filament axis 100 extends along a straight line when engaged by the tool. In FIG. 6, an example is shown in which the filaments near the bottom of this figure have been shaped with a tool and the filaments 52 do not have the same cross-sectional shape. Such a configuration may more likely be obtained when a filament 52 is shaped with a tool that moves with respect to a filament 52 or when a filament 52 is shaped with the tool after a filament 52 has been bent, curled, or are looped, such as by forming a filament 52 after exiting the funnel 74.

The second cross-sectional shape may be an asymmetric cross-sectional shape that differs from the cross-sectional shape of the filament 52 when the filament 52 was extruded. An asymmetric cross-sectional shape may be a shape lacking symmetry with respect to the filament axis or center axis of the filament 52. One or more members of the set of filaments 52 can comprise the same asymmetrical cross-sectional shapes or different asymmetrical cross sectional shapes. In some configurations, the second cross-sectional shape extends continuously along the length of a filament 52 or continuously in a direction that extends along or parallel to the filament axis 100. In some configurations, the second cross-sectional shape is provided in a localized area of the filament 52 and does not extend continuously along the length of a filament 52. In some configurations in which the second cross-sectional shape is localized, a filament 52 may comprise an asymmetric cross-sectional shape along an exterior side (e.g., outside side, outside surface, periphery, etc.) of the mesh member 90 and a symmetrical cross-sectional shape (e.g., having symmetry around or with respect to the filament axis 100, a cross-sectional shape of the filament when the filament was extruded, etc.) in one or more locations where the filament 52 is not shaped by the tool, such as where the filament 52 is inside the mesh member 90 or bent, looped, or bonded inside the mesh member 90.

Referring to FIGS. 5 and 6, in some configurations the second cross-sectional shape comprises a first portion 120 and a second portion 122.

The first portion 120 may be a side or surface that is engaged by the tool. Thus, the first portion 120 may be a portion of the filament 52 that is shaped by the tool to change the cross-sectional shape of the filament 52 and may be part of an exterior side of a membrane of the mesh member 90. In some configurations, the first portion 120 has a flat or planar configuration. The first portion 120 may comprise a first edge or first end 124 and a second edge or second end 126. The first end 124 and the second end 126 may be disposed opposite each other. A first end 124 and a second end 126 of the center filament are not labeled in these figures for clarity.

The second portion 122 extends from the first portion 120. In some configurations, the second portion 122 is not engaged by the tool. In some configurations, the second portion 122 extends from the first end 124 to the second end 126. In some configurations, the second portion 122 is non-planar. In the example in FIG. 5, the second portion 122 is depicted as extending along identical or substantially similar arcs. In the example in FIG. 6, the second portions 122 are depicted as extending along arcs that differ from each other.

Referring to FIGS. 5-7, members of the set of filaments 52 that are formed with the tool may join to form a membrane 130 (e.g., thin pliable sheet of material forming a cover, boundary, or barrier, a skin or contiguous sheet formed by shaping and joining filaments, the membrane being air permeable or air impermeable, etc.). The membrane 130 is disposed along or formed along at least a portion of an exterior side 110 or defines at least a portion of an exterior side 110 of the mesh member 90. For instance, members of the set of filaments 52 may be shaped by the tool to shape, flatten, spread, or smear a portion of a filament 52 so that one filament 52 may contact another filament 52 and form the membrane 130. The membrane 130 is partially represented by the dashed line in FIGS. 5 and 6. In some configurations, the membrane 130 is a contiguous membrane in which filaments 52 are connected throughout in an unbroken sequence along the exterior side 110, thereby forming a membrane 130 that is air impermeable (e.g., does not allow air to pass through, nonporous, etc.). Thus, the tool may shape or form filaments 52 to provide one or more asymmetric cross-sectional shapes and the membrane 130 may be formed where the asymmetric cross-sectional shapes become contiguous (e.g., touch, contact, or connected in sequence) or are contiguous. It is contemplated that the membrane 130 is not a separate film that is attached to or extruded onto the mesh member 90.

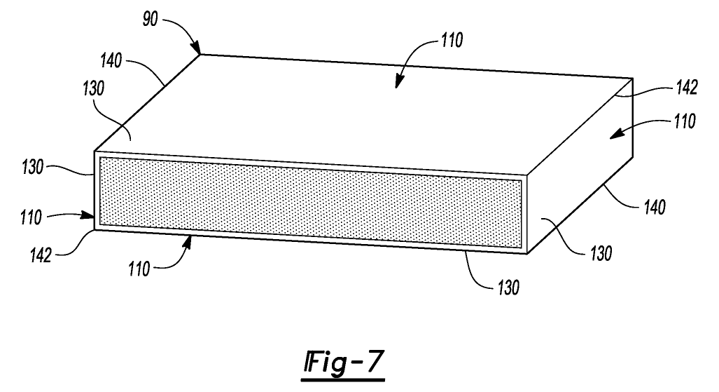

Referring to FIG. 7, in some configurations the exterior side 110 comprises or more edges (e.g., border, boundary, margin, outer limit, points for one exterior side meets another exterior side, etc.), such as a first edge 140 and a second edge 142 that is disposed opposite the first edge 140. In some configurations, the membrane 130 may extend from the first edge 140 to the second edge 142. At least some members of the set of filaments 52 that form the membrane 130 may be contiguous from the first edge 140 to the second edge 142.

In some configurations, at least a portion of a first member of the set of filaments 52 extends from (e.g., contacts, is bonded to at one or more points, etc.) a second member of the set of filaments 52 that differs from the first member. In some configurations, the first member of the set of filaments 52 extends from the second member of the set of filaments 52 only along or at an exterior side 110 of the mesh member 90 to help form the membrane 130. In some configurations, the first member of the set of filaments 52 extends from the second member of the set of filaments 52 only along or at one or more locations within the mesh member 90, such as points where filaments 52 contact after being bent, looped, or curled. Said differently, one or more filaments 52 may contact inside the mesh member 90 rather than at the membrane 130, such as when one or more filaments 52 intervene between the first and second members of the set of filaments. In some configurations, the first member of the set of filaments 52 extends from the second member of the set of filaments 52 along or at an exterior side 110 of the mesh member 90 to help form the membrane 130 and along or at one or more locations within the mesh member 90.

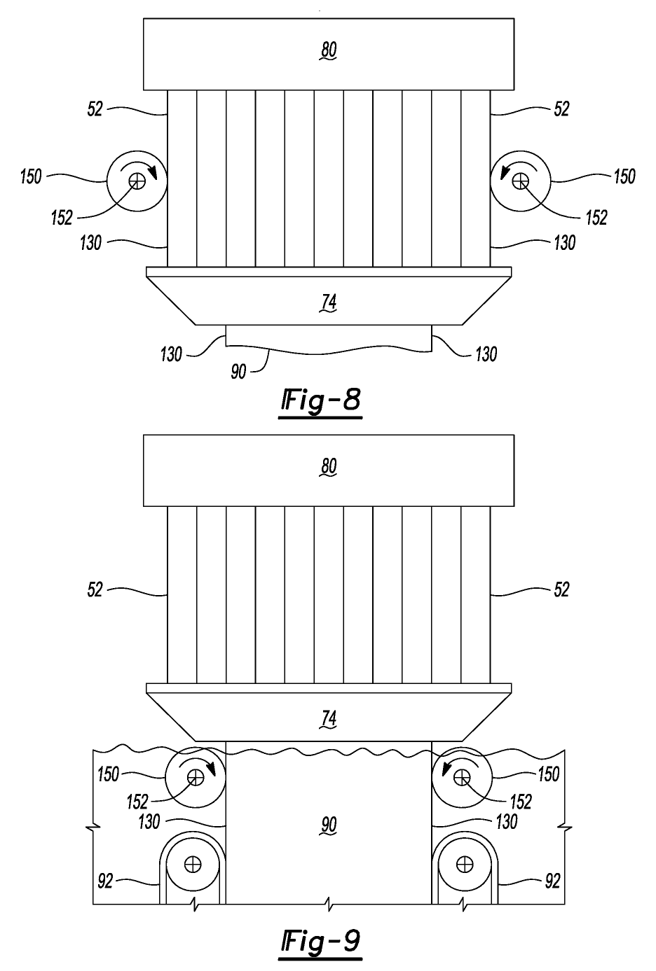

Referring to FIGS. 8-13, various tool configurations and methods of manufacture will now be discussed. In these figures, only some filaments 52 that are extruded from the die 80 are labeled and shown for simplicity. Additional filaments 52 that are extruded from the die 80 may be positioned behind the filaments 52 that extend downward from the die 80 in these figures. One filament 52 may not contact another filament 52 when it exits the die 80. Thus, one or more additional filaments 52 may be extruded behind an illustrated filament 52 and may be spaced apart from and not contact another filament 52 when it exits the die 80.

In some configurations, additional filaments 52 are arranged in rows that may be positioned behind the illustrated filaments 52 from the perspective shown in FIGS. 8-12. It is also contemplated that additional filaments 52 may be arranged such that an additional filament 52 is positioned directly behind an illustrated filament 52 from the perspective shown, an additional filament 52 is offset left or right with respect to an illustrated filament 52 from the perspective shown (i.e., not directly behind an illustrated filament 52), or combinations thereof.

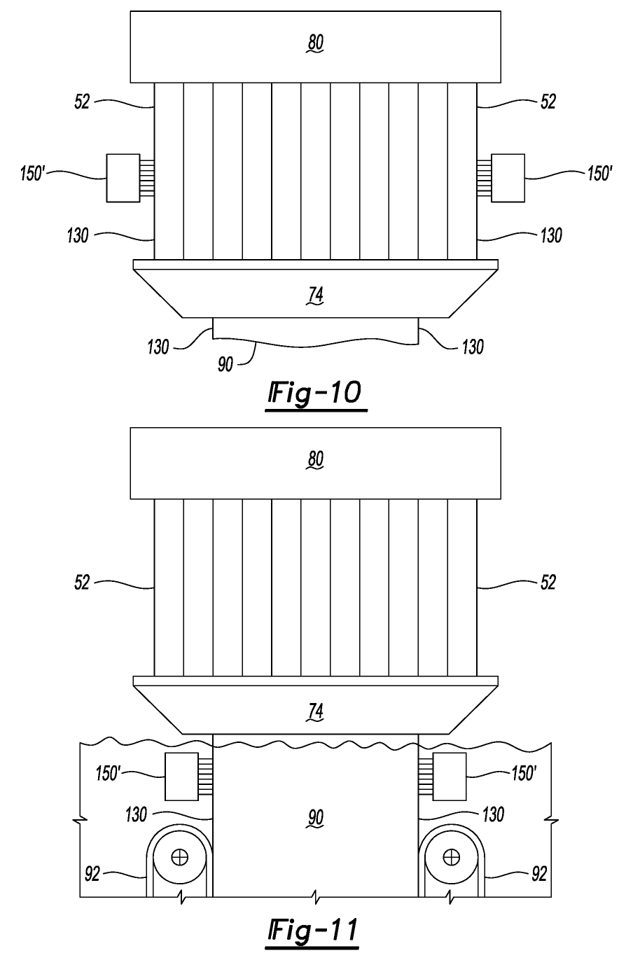

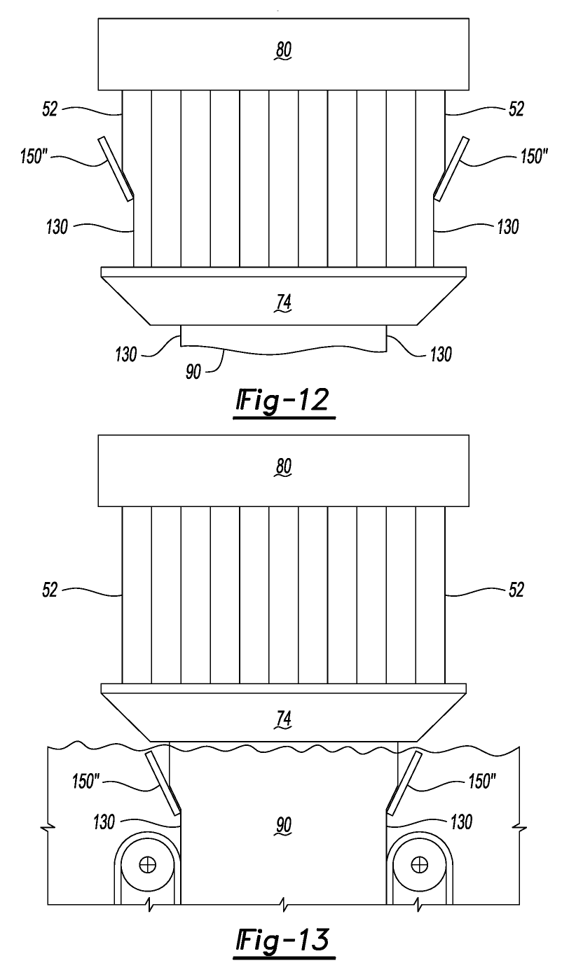

In the discussion below, the tool is generically referenced with reference number 150. One or more prime symbols (‘) are added to reference number 150 to help designate particular tool configurations. For instance, reference number 150 is used in FIGS. 8 and 9, reference number 150’ is used in FIGS. 10 and 11, and reference number 150’’ is used in FIGS. 12 and 13.

In some configurations, the tool 150, 150’, 150’’ shapes at least some members of the set of filaments 52 before the filaments 52 enter the funnel 74 (e.g., above the funnel 74, before entering the funnel inlet, between the extrusion die 80 and the funnel 74, in the area above the funnel 74 where filaments 52 freefall from the extrusion die 80, etc.). Examples of such configurations are shown in FIGS. 8, 10, and 12. In some configurations, the tool 150, 150’, 150’’ shapes at least some members of the set of filaments 52 after the filaments 52 exit the funnel 74 (e.g., below the funnel 74, after exiting the funnel outlet, between the funnel outlet and liquid in the cooling tank 76, above the liquid in the cooling tank 76, below the liquid or water line in the cooling tank 76 and above the tractor conveyor 92, etc.). Examples of such configurations are shown in FIGS. 9, 11, and 13.

It is contemplated that multiple tools 150, 150’, 150’’ may be provided such that at least one tool shapes at least some members of the set of filaments 52 before the filaments 52 enter the funnel 74 and that at least one other tool shapes at least some members of the set of filaments 52 after the filaments 52 exit the funnel 74. It is also contemplated that the different tool configurations or types of tools may be employed in combination in the manufacturing process rather than a single tool configuration or type of tool.

Referring to FIGS. 8 and 9, the tool 150 comprises at least one roller. In some configurations, the roller is a revolving cylinder that is rotatable about an axis 152. In some configurations, the roller or tool 150 and axis 152 are oriented or positioned perpendicular to a vertical axis or perpendicular to the direction in which the filaments 52 exit the die 80.

In some configurations, the roller or tool 150 has a length that is greater than the length of an exterior side 110 of the mesh member 90 and thus can shape multiple filaments 52 to form a membrane 130 that extends across an entire exterior side 110 of the mesh member 90. In some configurations, the roller or tool 150 has a length that is less than the length of an exterior side 110 of the mesh member 90 and thus can shape filaments 52 to form a membrane 130 that extends partially across an exterior side 110 of the mesh member 90.

One or more rollers or tools 150 may be employed. In the examples shown in FIGS. 8 and 9, two rollers are shown that are positioned along opposite sides or at opposite ends of the set of filaments 52. Thus, rollers or tools 150 can form filaments 52 into a membrane 130 along different sides of the mesh member 90. It is contemplated that a different number of rollers may be provided. For instance, a single roller or tool 150 may be provided to form filaments 52 into a membrane 130 along at least a portion of one exterior side 110 of the mesh member 90 or more than two rollers may be provided to form filaments 52 into a membrane 130 along additional exterior sides 110 of the mesh member 90. For instance, an additional roller may be provided that extends left to right across one or more filaments 52 to shape filaments 52 arranged along a side closest to the viewer from the perspective shown in FIGS. 8 and 9. In some configurations, such a roller or tool 150 or may be positioned above or below the rollers that are illustrated in FIG. 8 so that the roller does not contact the illustrated rollers.

In some configurations, rollers form filaments 52 into a membrane 130 along each exterior side 110 of the mesh member 90, which may produce a continuous membrane 130 that circumscribes (e.g., bounds, encompasses, encircles, encloses, extends around, etc.) an air permeable interior (e.g., inner or interior part of the mesh member that allows air to pass through) of the mesh member 90. An example of such a mesh member 90 is shown in FIG. 7 in which a continuous membrane 130 is disposed on four sides of the mesh member 90 that surrounds or encompasses a cross-section of the mesh member 90. Such a configuration may produce a tubelike structure in which the membrane 130 is air impermeable while the internal region or air permeable interior of the mesh member 90 that is bounded by the continuous membrane 130 permits air to flow or pass through the voids between filaments 52 in the internal region.

In some configurations, the air permeable interior of the mesh member 90 is at least partially comprised of members of the set of filaments 52 that form the membrane 130. In some configurations, at least some members of the set of filaments 52 comprising the membrane 130 are bonded to each other in the air permeable interior of the mesh member 90, unlike a separate film or additional filaments that are dispensed onto an exterior side of a mesh member 90, which may simplify manufacturing and reduce manufacturing steps.

Referring to FIG. 8, one or more rollers or tools 150 are positioned above the funnel 74. As such, one or more filaments 52 may be shaped into a membrane 130 or a portion of a membrane 130 above the funnel 74. The membrane 130 or portion of a membrane 130 may then enter the funnel 74 and slide along the funnel 74 or an intervening sheet that is disposed on the funnel 74 toward the funnel outlet. Other filaments 52 or regions of filaments 52 that extend from or that are spaced apart from the membrane 130 may bend, loop, or curl onto the membrane 130 or onto other filaments 52 in the funnel 74 or as filaments 52 pass through the funnel 74 to build the mesh member 90. In some configurations, it is contemplated that a portion of a membrane 130 may fold back upon itself to help the filaments 52 and membrane 130 to fit through the outlet of the funnel 74.

Referring to FIG. 9, one or more rollers or tools 150 are positioned below the funnel 74. As such, one or more filaments 52 may be shaped into a membrane 130 below the funnel 74. The roller or rollers may be positioned above the tractor conveyor 92 or may engage filaments 52 of the mesh member 90 before being engaged by the tractor conveyor 92.

In some configurations, the roller or rollers are positioned to engage filaments 52 of the mesh member 90 before the mesh member 90 enters the cooling tank 76. Positioning the roller or rollers in this manner may form the membrane 130 before the mesh member 90 enters the cooling tank 76 and help ensure that the filaments 52 are in a molten state when engaged by the roller or rollers.

In some configurations, the roller or rollers are positioned to engage filaments 52 of the mesh member 90 in the cooling tank 76. For instance, the roller or rollers may be partially or completely submerged in the liquid in the cooling tank 76 and may be located near the surface of the liquid so that the roller or rollers can shape the filaments 52 into a membrane 130 before the liquid cools the filaments 52 to a point at which the filaments 52 are no longer in a molten state or are unable to be shaped and bond at additional locations to form a membrane 130.

In some configurations, the roller or rollers rotate faster than the tractor conveyor 92. Rotating the rollers faster than the tractor conveyor 92 may help shape, spread, flatten, or smear the filaments 52 that are engaged by the roller or rollers to form the membrane 130 rather than acting as an additional tractor conveyor 92 that helps pull the mesh member 90 into the liquid without shaping the filaments 52 into a membrane 130. It is also contemplated that the rollers may exert less pressure on the filaments 52 of the mesh member 90 than the tractor conveyor 92 does. Exerting less pressure with the rollers may allow the tractor conveyor 92 to control the feed rate of the mesh member 90 downstream from the funnel 74, such as in the cooling tank 76, while allowing the rollers to rotate or spin and shape, spread, flatten, or smear filaments 52 into a membrane 130.

Referring to FIGS. 10 and 11, the tool 150’ comprises at least one brush. In some configurations, the brush is a bristled member or has bristles like a broom that engage or contact one or more filaments as the filaments 52 move across the brush or with respect to the brush.

One or more brushes may be employed. In the example shown in FIGS. 10 and 11, two brushes are shown that are positioned along opposite sides or at opposite ends of the set of filaments 52. Thus, the brushes can form filaments 52 into a membrane 130 along different sides of the mesh member 90. It is contemplated that a different number of brushes may be provided. For instance, a single brush may be provided to form filaments 52 into a membrane 130 along at least a portion of one exterior side 110 of the mesh member 90 or more than two brushes may be provided to form filaments 52 into a membrane 130 along additional exterior sides 110 of the mesh member 90. For instance, an additional brush may be provided that extends left to right across one or more filaments 52 to shape filaments 52 arranged along a side closest to the viewer from the perspective shown in FIG. 10 and 11.

In some configurations, brushes may be provided to form filaments 52 into a membrane 130 along each exterior side 110 of the mesh member 90, which may produce a continuous membrane 130 that circumscribes (e.g., bounds, encompasses, encircles, encloses, extends around, etc.) an air permeable interior of the mesh member 90 as previously discussed.

Referring to FIG. 10, one or more brushes are positioned above the funnel 74. As such, one or more filaments 52 may be shaped into a membrane 130 or a portion of a membrane 130 above the funnel 74. The membrane 130 may then enter the funnel 74 and slide along the funnel 74 or an intervening sheet that is disposed on the funnel 74 toward the funnel outlet. Other filaments 52 or regions of filaments 52 that extend from or spaced apart from the membrane 130 may bend, loop, or curl onto the membrane 130 or onto other filaments 52 in the funnel 74 or as filaments 52 pass through the funnel 74 to build the mesh member 90. In some configurations, it is contemplated that a portion of a membrane 130 may fold back upon itself to help the filaments 52 and membrane 130 to fit through the outlet of the funnel 74.

Referring to FIG. 11, one or more brushes are positioned below the funnel 74. As such, one or more filaments 52 may be shaped into a membrane 130 below the funnel 74. The brush or brushes may be positioned above the tractor conveyor 92 or may engage filaments 52 of the mesh member 90 before being engaged by the tractor conveyor 92.

In some configurations, the brush or brushes are positioned to engage filaments 52 of the mesh member 90 before the mesh member 90 enters the cooling tank 76. Positioning the brush or brushes in this manner may form the membrane 130 before the mesh member 90 enters the cooling tank 76 and help ensure that the filaments 52 are in a molten state when engaged by the brush or brushes.

In some configurations, the brush or brushes are positioned to engage filaments 52 of the mesh member 90 in the cooling tank 76. For instance, the brush or brushes may be partially or completely submerged in the liquid in the cooling tank 76 and may be located near the surface of the liquid so that the brush or brushes can shape the filaments 52 into a membrane 130 before the liquid cools the filaments 52 to the point that the filaments 52 are no longer in a molten state or are unable to be shaped and bond at additional locations to form a membrane 130.

Referring to FIGS. 12 and 13, the tool 150’’ comprises at least one blade. In some configurations, the blade is a member, frame, knife, or the like comprising a side, edge, rim, or lip that engages or contacts one or more filaments as the filaments 52 move across or with respect to the blade. The blade shapes or flattens a filament 52 and allows the flattened filament 52 to drop from the edge, rim, or lip of the blade.

One or more blades may be employed. In the example shown in FIGS. 12 and 13, two blades are shown that are positioned along opposite sides or at opposite ends of the set of filaments 52. Thus, blades can form filaments 52 into a membrane 130 along different sides of the mesh member 90. It is contemplated that a different number of blades may be provided. For instance, a single blade may be provided to form filaments 52 into a membrane 130 along at least a portion of one exterior side 110 of the mesh member 90 or more than two blades may be provided to form filaments 52 into a membrane 130 along additional exterior sides 110 of the mesh member 90. For instance, an additional blade may be provided that extends left to right across one or more filaments 52 to shape filaments 52 arranged along a side closest to the viewer from the perspective shown in FIG. 12 and 13.

In some configurations, blades may be provided to form filaments 52 into a membrane 130 along each exterior side 110 of the mesh member 90, which may produce a continuous membrane 130 that circumscribes (e.g., bounds, encompasses, encircles, encloses, extends around, etc.) an air permeable interior of the mesh member 90 as previously discussed.

Referring to FIG. 12, one or more blades are positioned above the funnel 74. As such, one or more filaments 52 may be shaped into a membrane 130 or a portion of a membrane 130 above the funnel 74. The membrane 130 may then enter the funnel 74 and slide along the funnel 74 or an intervening sheet that is disposed on the funnel 74 toward the funnel outlet. Other filaments or portions of filaments 52 that extend from or spaced apart from the membrane 130 may bend, loop, or curl on the membrane 130 or on other filaments 52 in the funnel 74 or as filaments 52 pass through the funnel 74 to build the mesh member 90. In some configurations, it is contemplated that a portion of a membrane 130 may fold back upon itself to help the filaments 52 and membrane 130 to fit through the outlet of the funnel 74.

Referring to FIG. 13, one or more blades are positioned below the funnel 74. As such, one or more filaments 52 may be shaped into a membrane 130 below the funnel 74. The blade or blades may be positioned above the tractor conveyor 92 or may engage filaments 52 of the mesh member 90 before being engaged by the tractor conveyor 92.

In some configurations, the blade or blades are positioned to engage filaments 52 of the mesh member 90 before the mesh member 90 enters the cooling tank 76. Positioning the blade or blades in this manner may form the membrane 130 before the mesh member 90 enters the cooling tank 76 and help ensure that the filaments 52 are in a molten state when engaged by the blade or blades.

In some configurations, the blade or blades are positioned to engage filaments 52 of the mesh member 90 in the cooling tank 76. For instance, the blade or blades may be partially or completely submerged in the liquid in the cooling tank 76 and may be located near the surface of the liquid so that the blade or blades can shape the filaments 52 into a membrane 130 before the liquid cools the filaments 52 to the point that the filaments 52 are no longer in a molten state or are unable to be shaped and bond at additional locations to form a membrane 130.

The present invention may allow a mesh member to be manufactured with a membrane on one or more sides. The membrane may help provide more material along the exterior side as compared to the interior of the mesh member or compared to a mesh member that does not include a membrane, which may help reduce the porosity or number of voids in the exterior of the mesh member. Reducing the porosity may help provide a smoother exterior surface that may be more supportive to a seat occupant or may be more comfortable to a seat occupant. Reducing the porosity may allow the mesh member to be employed as a conduit that directs airflow through the mesh member, which may help direct airflow to a desired location, such as toward or from the seat occupant when employed as part of a ventilated seat. Reducing the porosity may provide more surface area along the mesh member for attachment of other components, such as a trim cover.

The addition of a membrane may help provide localized reinforcement or strengthening of the mesh member, which may help the mesh member better withstand load forces or improve durability.

The membrane may be provided during the initial manufacture of the mesh member when filaments are in a molten state, which may avoid manufacturing steps associated with providing and attaching a separate membrane to the mesh member or dispensing additional filaments that form a membrane after the mesh member has been formed and hardened. This in turn may reduce manufacturing time, reduce capital investment in equipment, material handling, and additional manufacturing steps.

Forming filaments into a membrane may facilitate recycling of the mesh member with the membrane rather than removing the membrane to facilitate recycling, such as may be the case when a membrane is made of a different material than the filaments of the mesh member.

Clause 1. A mesh member, comprising: a set of filaments that are entangled and bonded together, the set of filaments defining an air permeable interior of the mesh member and an exterior side of the mesh member; and a membrane disposed along at least a portion of the exterior side of the mesh member, the membrane formed by members of the set of filaments that are shaped to have an asymmetric cross-sectional shape that differs from a cross-sectional shape of filaments within the air permeable interior of the mesh member.

Clause 2. The mesh member of clause 1, wherein the membrane is air impermeable.

Clause 3. The mesh member of clause 1 or 2, wherein the membrane is a contiguous membrane in which filaments are connected across an unbroken sequence along the exterior side.

Clause 4. The mesh member of any preceding clause, wherein the membrane extends along multiple exterior sides of the mesh member, forming a continuous membrane that circumscribes the air permeable interior of the mesh member.

Clause 5. The mesh member of any preceding clause, wherein the asymmetric cross-sectional shape comprises: a first portion having a planar configuration; and a second portion extending from the first portion, the second portion being non-planar.

Clause 6. The mesh member of clause 5, wherein the first portion comprises a first end and a second end disposed opposite each other, and the second portion extends from the first end to the second end.

Clause 7. The mesh member of any preceding clause, wherein at least some members of the set of filaments comprising the membrane are bonded to each other within the air permeable interior of the mesh member.

Clause 8. A method of manufacturing a mesh member, comprising: extruding a set of filaments from a die, each filament having a first cross-sectional shape when extruded; shaping a subset of the set of filaments with a tool while the set of filaments are in a molten state to change the first cross-sectional shape to a second cross-sectional shape that differs from the first cross-sectional shape; passing the set of filaments through a funnel to entangle and bond the set of filaments together to form the mesh member; and cooling the mesh member in a cooling tank containing a liquid.

Clause 9. The method of clause 8, wherein shaping the subset of the set of filaments with the tool forms a membrane along at least a portion of an exterior side of the mesh member.

Clause 10. The method of clause 9, wherein the membrane is air impermeable.

Clause 11. The method of any preceding clause, wherein the tool shapes the subset of the set of filaments before the set of filaments enter the funnel.

Clause 12. The method of any preceding clause, wherein the tool shapes the subset of the set of filaments after the set of filaments exit the funnel.

Clause 13. The method of any preceding clause, wherein the tool comprises at least one roller.

Clause 14. The method of clause 13, wherein a surface of the at least one roller rotates at a faster speed than a speed of the set of filaments exiting the die.

Clause 15. The method of any preceding clause, wherein the tool comprises at least one brush.

Clause 16. The method of any preceding clause, wherein the tool comprises at least one blade.

Clause 17. The method of any preceding clause, wherein the tool is positioned at least partially in the liquid in the cooling tank.

Clause 18. A seat assembly, comprising: a seat frame; and a cushion disposed on the seat frame, the cushion comprising a mesh member, the mesh member comprising: a set of filaments that are entangled and bonded together, the set of filaments defining an air permeable interior of the mesh member and an exterior side of the mesh member; and a membrane disposed along at least a portion of the exterior side of the mesh member, the membrane formed by members of the set of filaments that are shaped to have an asymmetric cross-sectional shape.

Clause 19. The seat assembly of clause 18, wherein the membrane is a continuous membrane that circumscribes the air permeable interior of the mesh member.

Clause 20. The seat assembly of clause 18 or 19, further comprising a trim cover disposed on the cushion.

Clause 21. A mesh member comprising: a set of filaments of thermoplastic material, wherein each member of the set of filaments is bonded to at least one other member of the set of filaments; and wherein one or more members of the set of filaments comprise asymmetrical cross-sectional shapes along an exterior side of the mesh member.

Clause 22. The mesh member of clause 21 wherein members of the set of filaments comprising asymmetrical cross-sectional shapes form a membrane along at least a portion of the exterior side of the mesh member.

Clause 23. The mesh member of clause 22 wherein the membrane is air impermeable.

Clause 24. The mesh member of clause 23 wherein the membrane circumscribes an air permeable interior of the mesh member.

Clause 25. The mesh member of clause 24 wherein the air permeable interior of the mesh member is at least partially comprised of members of the set of filaments that form the membrane.

Clause 26. The mesh member of clause 24 or clause 25 wherein at least some members of the set of filaments comprising the membrane are bonded to each other in the air permeable interior.

Clause 27. The mesh member of any one of clauses 22 to 26 wherein the exterior side comprises a first edge and a second edge opposite the first edge, and wherein the membrane extends from the first edge to the second edge.

Clause 28. The mesh member of any preceding clause wherein one or more members of the set of filaments comprising asymmetrical cross-sectional shapes along the exterior side of the mesh member further comprise a symmetrical cross-section shape within the mesh member.

Clause 29. A method comprising: extruding a set of filaments of thermoplastic material; and shaping, with a tool, at least some members of the set of filaments into a membrane when the filaments are in a molten state.

Clause 30. The method of clause 29 wherein shaping filaments forms the membrane along at least a portion of an exterior side of a mesh member, the mesh member comprising the set of filaments of thermoplastic material, wherein each member of the set of filaments is bonded to at least one other member of the set of filaments.

Clause 31. The method of clause 29 or clause 30 wherein shaping filaments forms the membrane into an air impermeable membrane.

Clause 32. The method of any one of clauses 29 to 31 further comprising passing the set of filaments through a funnel, the funnel consolidating the set of filaments into a mesh member such that each member of the set of filaments is bonded to at least one other member of the set of filaments.

Clause 33. The method of clause 32 wherein shaping at least some members of the set of filaments with the tool occurs before the set of filaments enters the funnel.

Clause 34. The method of clause 32 or clause 33 wherein shaping at least some members of the set of filaments with the tool occurs after the set of filaments exits the funnel.

Clause 35. The method of clause 34 wherein shaping at least some members of the set of filaments with the tool occurs in liquid in a cooling tank.

Clause 36. The method of any one of clauses 29 to 35 wherein the tool comprises at least one roller.

Clause 37. The method of clauses 29 to 35 wherein the tool comprises at least one brush.

Clause 38. The method of clauses 29 to 35 wherein the tool comprises at least one blade.

Clause 39. The method of clauses 29 to 38 wherein shaping comprises changing a cross-sectional shape of at least some members of the set of filaments with the tool.

Clause 40. The method of clause 39 wherein changing the cross-sectional shape forms an asymmetrical cross-sectional shape.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A mesh member, comprising:
a set of filaments that are entangled and bonded together, the set of filaments defining an air permeable interior of the mesh member and an exterior side of the mesh member; and
a membrane disposed along at least a portion of the exterior side of the mesh member, the membrane formed by members of the set of filaments that are shaped to have an asymmetric cross-sectional shape that differs from a cross-sectional shape of filaments within the air permeable interior of the mesh member.

2. The mesh member of claim 1, wherein the membrane is air impermeable.

3. The mesh member of claim 1, wherein the membrane is a contiguous membrane in which filaments are connected across an unbroken sequence along the exterior side.

4. The mesh member of claim 1, wherein the membrane extends along multiple exterior sides of the mesh member, forming a continuous membrane that circumscribes the air permeable interior of the mesh member.

5. The mesh member of claim 1, wherein the asymmetric cross-sectional shape comprises:
a first portion having a planar configuration; and
a second portion extending from the first portion, the second portion being non-planar.

6. The mesh member of claim 5, wherein the first portion comprises a first end and a second end disposed opposite each other, and the second portion extends from the first end to the second end.

7. The mesh member of claim 1, wherein at least some members of the set of filaments comprising the membrane are bonded to each other within the air permeable interior of the mesh member.

8. A method of manufacturing a mesh member, comprising:
extruding a set of filaments from a die, each filament having a first cross-sectional shape when extruded;
shaping a subset of the set of filaments with a tool while the set of filaments are in a molten state to change the first cross-sectional shape to a second cross-sectional shape that differs from the first cross-sectional shape;
passing the set of filaments through a funnel to entangle and bond the set of filaments together to form the mesh member; and
cooling the mesh member in a cooling tank containing a liquid.

9. The method of claim 8, wherein shaping the subset of the set of filaments with the tool forms a membrane along at least a portion of an exterior side of the mesh member.

10. The method of claim 9, wherein the membrane is air impermeable.

11. The method of claim 8, wherein the tool shapes the subset of the set of filaments before the set of filaments enter the funnel.

12. The method of claim 8, wherein the tool shapes the subset of the set of filaments after the set of filaments exit the funnel.

13. The method of claim 8, wherein the tool comprises at least one roller.

14. The method of claim 13, wherein a surface of the at least one roller rotates at a faster speed than a speed of the set of filaments exiting the die.

15. The method of claim 8, wherein the tool comprises at least one brush.

16. The method of claim 8, wherein the tool comprises at least one blade.

17. The method of claim 8, wherein the tool is positioned at least partially in the liquid in the cooling tank.

18. A seat assembly, comprising:
a seat frame; and
a cushion disposed on the seat frame, the cushion comprising a mesh member, the mesh member comprising:
a set of filaments that are entangled and bonded together, the set of filaments defining an air permeable interior of the mesh member and an exterior side of the mesh member; and
a membrane disposed along at least a portion of the exterior side of the mesh member, the membrane formed by members of the set of filaments that are shaped to have an asymmetric cross-sectional shape.

19. The seat assembly of claim 18, wherein the membrane is a continuous membrane that circumscribes the air permeable interior of the mesh member.

20. The seat assembly of claim 18, further comprising a trim cover disposed on the cushion.
